(19) United States
(12) Patent Application Publication
(10) Pub. No.: US 2004/0149881 A1
(43) Pub. Date: Aug. 5, 2004

(54) ADJUSTABLE SUPPORT STRUCTURE FOR AIR CONDITIONER AND THE LIKE

(76) Inventor: David S. Allen, Haslett, MI (US)

Correspondence Address: FOSTER, SWIFT, COLLINS & SMITH, P.C., 313 SOUTH WASHINGTON SQUARE, LANSING, MI, 48933, US

(21) Appl. No.: 10/707,467

(22) Filed: Dec. 16, 2003

Related U.S. Application Data
(60) Provisional application No. 60/444,035, filed on Jan. 31, 2003.

(51) Int. Cl. F16M 1/00

(52) U.S. Cl. 248/676

(57) ABSTRACT

An adjustable support structure for supporting an object adjacent to a building, includes a first support assembly and a second support assembly telescopically connected. One of the first support assembly and the second support assembly includes at least one upwardly extending leg member and is configured to be positioned on a surface substantially perpendicular to the at least one leg member. The other of the first support assembly and the second support assembly includes a top support plate configured to support an object adjacent to the building, and is adjustable between a plurality of vertical positions relative to the surface. The adjustable support structure may also include at least one component connected to one of the first and second support assemblies to add lateral support and enhanced aesthetics.

### CROSS REFERENCE TO RELATED APPLICATIONS

This application claims priority to a provisional patent application serial No. 60/444,035 entitled, “Adjustable support structure for air conditioner and the like,” filed Jan. 31, 2003. The entire disclosure of serial No. 60/444,035 is incorporated herein by reference in its entirety.

### BACKGROUND OF INVENTION

1. Field of the Invention

The present invention generally relates to support structures and particularly to an adjustable support structure suitable for supporting an object such as an air conditioning unit or flower planter that has been mounted to a window.

2. Discussion of Prior Art

There are many types of support structures known in the art to support an object such as an air conditioning unit or flower planter that have been mounted to a window in a building, home or other similar structure. Many of these types of supports require mounting to the same building to which the object is mounted. These supports can be expensive and complicated to install. In addition, because these types of support structures are mounted directly to the building, they may transfer unwanted noise and vibration created by an air conditioner back into the building. Further, holes or mounting components may need to be placed on the structure to secure the support structure to the building. This can be aesthetically unattractive and expensive. Existing support structures also typically require some type of attachment to the air conditioning unit itself, which further increases costs and difficulty of installation.

In general, existing types of structures configured to support an object such as an air conditioner are aesthetically unattractive, due to their complexity and mechanical structure. Thus, there is a desire and a need in the art to provide a support structure that is easily installed, requires no additional attachment components to the building or air conditioning unit, and is aesthetically pleasing. There is further a need to provide a support structure that is vertically adjustable and designed to transfer the vibration created by the air conditioning unit to the ground.

### SUMMARY OF INVENTION

Accordingly, the present invention provides an adjustable support structure configured to support an object, such as an air conditioning unit or flower planter that has been mounted to a window or the outside of a building, home or other similar structure. The adjustable support structure of the present invention is easily installed, low in cost, and aesthetically pleasing.

In one embodiment of the present invention, an adjustable support structure to support an object adjacent to a building, includes a first support assembly and a second support assembly telescopically connected to the first support assembly. One of the first support assembly and the second support assembly includes at least one upwardly extending leg member and is configured to be positioned on a surface substantially perpendicular to the at least one upwardly extending leg member. The other of the first support assembly and the second support assembly includes a top support plate configured to support an object adjacent to the building and is adjustable between a plurality of vertical positions relative to the surface.

In another embodiment of the present invention, a support structure includes an upper support assembly having an upper support plate and at least one downwardly extending leg member perpendicular to the upper support plate. A lower support assembly is included having a lower support plate and at least one upwardly extending leg member perpendicular to the lower support plate. The lower support plate is configured to be positioned on a surface substantially perpendicular to the at least one upwardly extending leg member and the upper support assembly is moveable between a plurality of vertical positions relative to the surface. The upper support assembly is configured to support an object connected to the building.

In yet another embodiment of the present invention, an adjustable support structure configured to support an object includes an upper support plate and at least one outer leg member connected to the upper support plate. A lower support plate includes at least one inner leg member connected to the lower support plate and is telescopically received within the at least one outer leg member.

The lower support plate is configured to be positioned on a surface substantially perpendicular to the at least one inner leg member and the upper support plate is configured to support the object at a selected vertical position relative to the surface.

### BRIEF DESCRIPTION OF DRAWINGS

The foregoing features, as well as other features, will become apparent with reference to the description and figures below, in which like numerals represent like elements, and in which:

FIG. 1 is a front perspective view of an embodiment of the present invention;

FIG. 2 is a sectional view taken along line 2-2 in FIG. 1;

FIG. 3 is an exploded front perspective view of an embodiment of the present invention; and

FIG. 4 is a front perspective view of an embodiment of the present invention shown in use supporting an air conditioning unit.

### DETAILED DESCRIPTION

The present invention generally relates to an adjustable support structure and particularly configured to support an object such as an air conditioning unit or flower planter that has been mounted to a window or outside surface of a building, home, or other similar structure. For purposes of this description the term “building” will be used and intended to refer to all similar structures and the term “object” will be used to refer to any possible object to be supported by the support structure of the present invention.

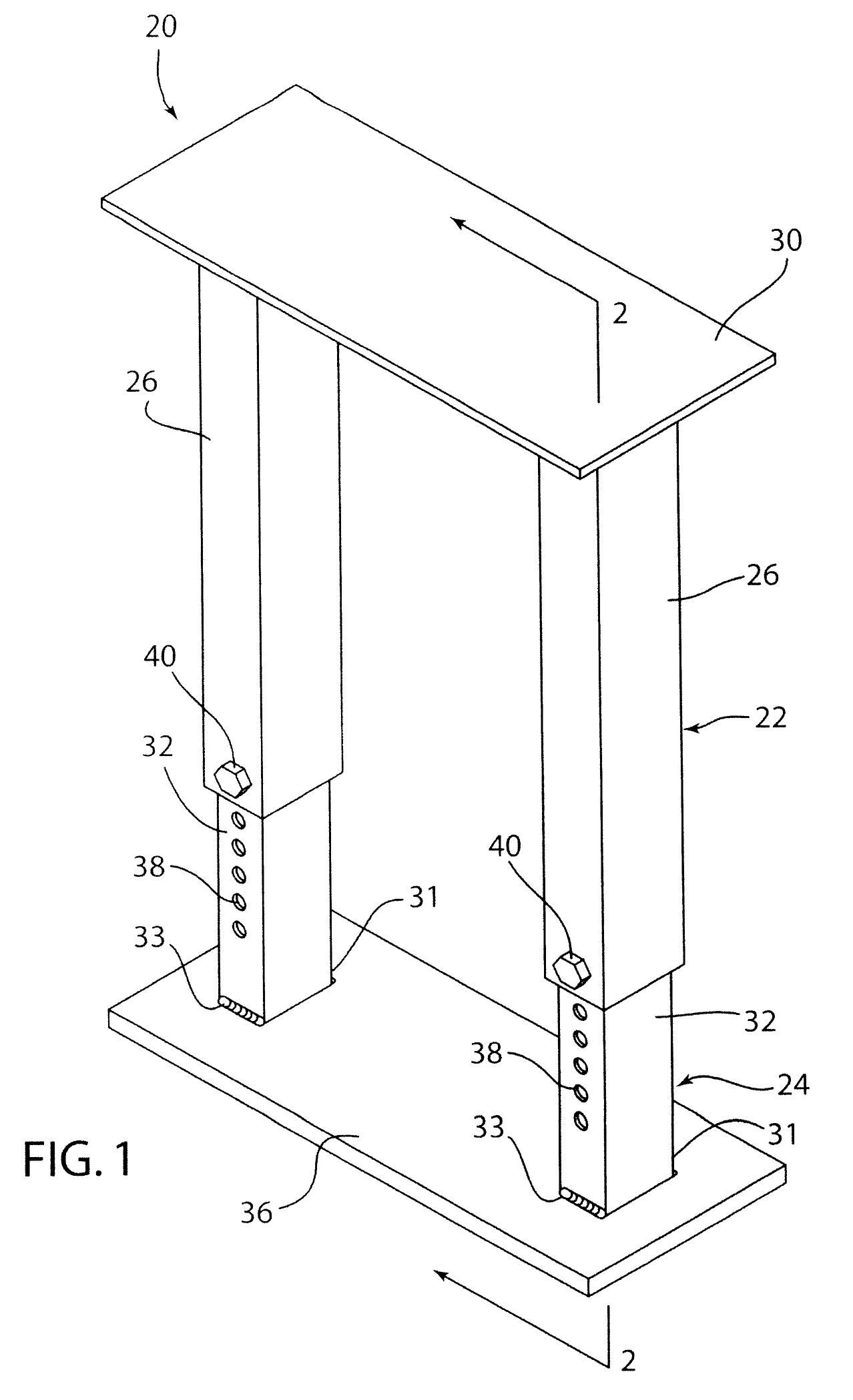

Referring to FIG. 1, a support structure 20 may include an upper support assembly 22 and a lower support assembly 24. Upper support assembly 22 may include an upper support plate 30 and at least one outer leg member 26 extending perpendicular from upper support plate 30. Outer leg members 26 as shown in the figures are generally rectangular shaped and tubular, however, outer leg member 26 could alternatively be round, oval or any other shaped tubular member. In addition, upper support assembly 22 is shown in the figures having a pair of outer leg members 26, but may include any desired number of outer leg members 26.

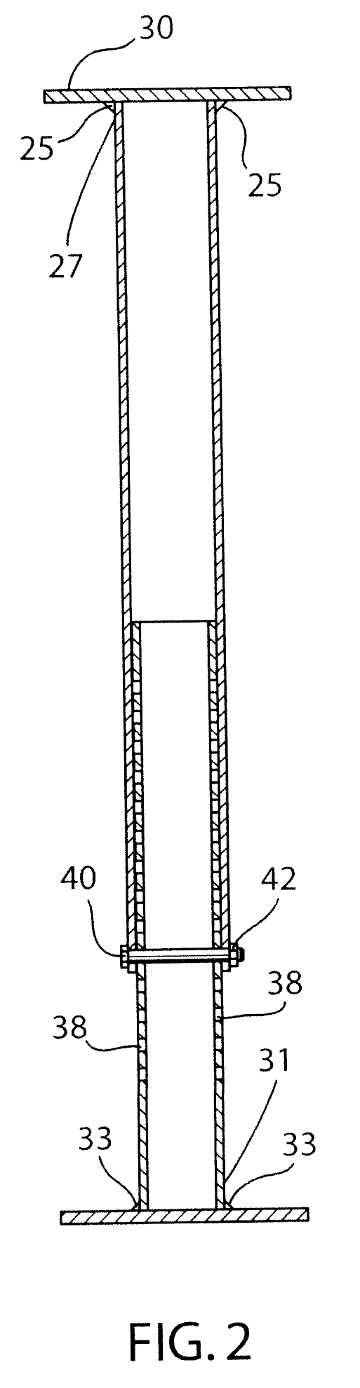

Upper support plate 30 may be connected to outer leg members 26 at a top end 27 of outer leg members 26 as shown with welds 25 in FIG. 2. Alternatively, upper support plate 30 may be attached by other attachment methods known in the art such as a threaded attachment using conventional bolts or screws (not shown). Upper support plate 30 and outer leg members 26 may be constructed of aluminum, steel or other metallic material capable of supporting the desired object. Alternatively, support plate 30 and outer leg members 26 may be made of plastic and connected together by sonic welding, threaded fasteners or other attachment means suitable for plastic components.

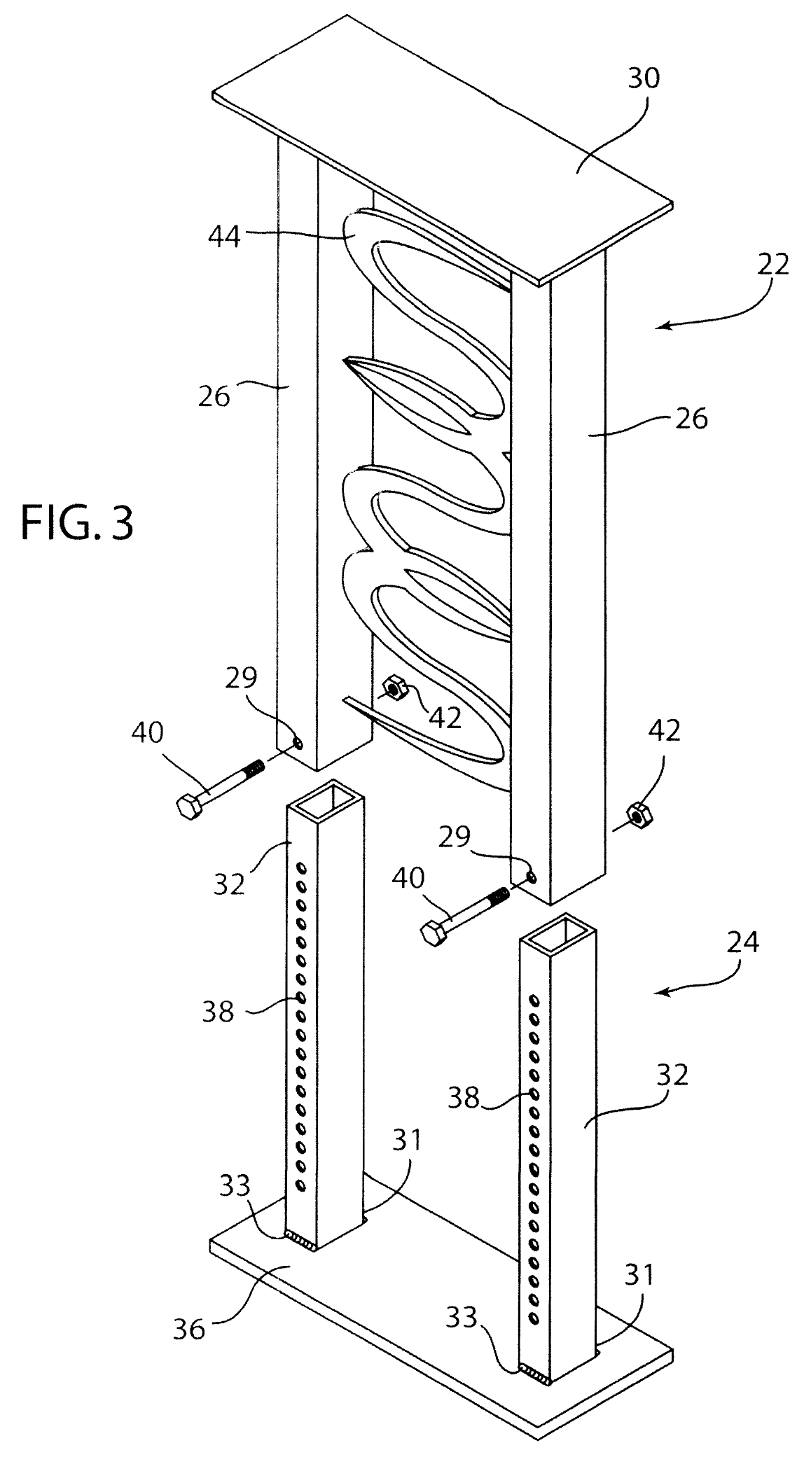

As shown in FIG. 3, outer leg members 26 may include at least one locking hole 29 configured to receive a bolt (or pin and the like) 40 that may be used to lock support structure 20 into a desired height configuration as will be described in more detail below.

Lower support assembly 24 may include a lower support plate 36 and at least one inner leg member 32 extending perpendicular to lower support plate 36. As shown in the figures, a pair of inner leg members 32 is provided that corresponds to the pair of outer leg members 26. Lower support plate 36 may be attached to inner leg members 32 at a bottom end 31 by the same methods as described above for upper support plate 30 as shown at welds 33 in the Figures. Lower support plate 36 and inner leg members 32 may also be constructed with the same materials as described above for upper support plate 30 and outer leg members 26. Inner leg members 32, as shown in the figures, are generally rectangular shaped and tubular, and sized such that the outside dimensions of inner leg members 32 are slightly smaller than the inside dimensions of outer leg members 26. This configuration allows inner leg members 32 to be telescopically received within outer leg members 26. Inner leg members 32 may each include a plurality of adjustment holes 38 that are configured to align with locking holes 29 as inner leg members 32 are slid telescopically within outer leg members 26. Although the figures illustrate inner leg members 32 telescopically received within outer leg members 26, it is obvious that the desired vertical adjustment of support structure 20 may be achieved by reversing this construction such that upper support assembly 22 includes leg members that are telescopically received within lower support assembly 24. Such a reversed configuration is considered to be within the scope of the present invention.

The telescoping configuration of the inner and outer leg members allows support structure 20 to be adjusted vertically to a desired height dimension to accommodate different uses. As best shown in FIG. 2, bolts 40 may be inserted through each locking hole 29 on the pair of outer leg members 26 and through a selected adjustment hole 38 to securely hold outer leg members 26 to inner leg members 32. As shown, a nut 42 may be threadably attached to the end of bolts 40 to lock the assembly in the desired vertical position. Nut 42 may be a locking nut as is known in the art. The adjustable capability of support structure 20 allows a user to change the vertical positioning of outer leg members 26 relative to inner leg members 32 as a user's needs may change. The user would simply remove bolts 40, slide upper support assembly 22 upward or downward to a desired height location and insert bolts 40 back through locking holes 29 and into the desired adjustment holes 38.

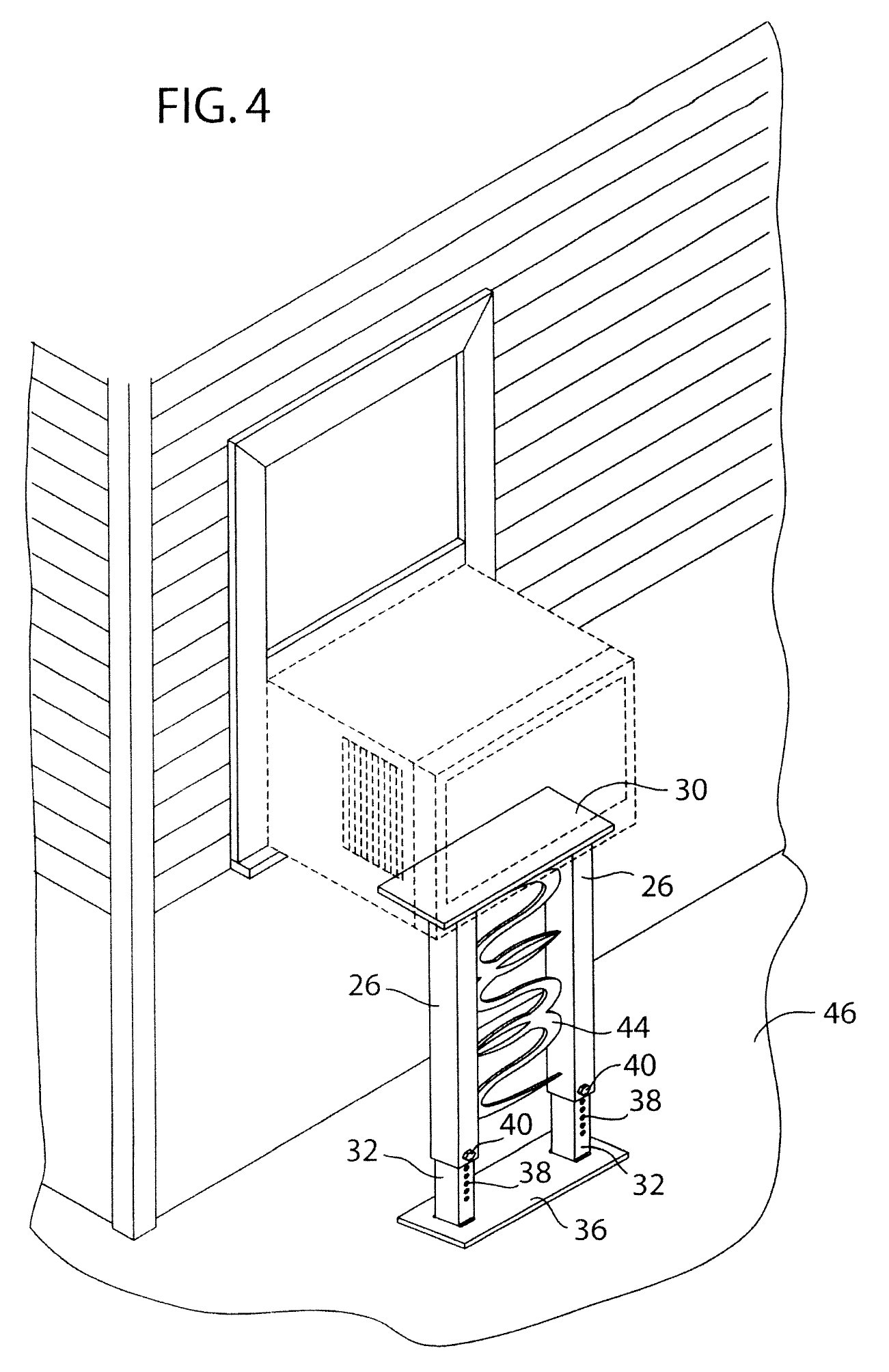

As shown in FIGS. 3 and 4, an optional component 44 may be added to support structure 20 configured to enhance or blend into its environment as well as provide lateral stability. Component 44 may be attached by a variety of attachment methods known in the art such as welding, molding, threaded fasteners, ties, snaps, hook and loop fasteners as sold under the trade name VELCRO. Adding component 44 to support structure 20 helps support structure 20 blend into the overall environment of the building and further adds to its novelty. As such, support structure 20 may be viewed as more than just a structural necessity to support the particular object, but as an added decorative feature of the surroundings for which it is used. Component 44 may include any number of designs and colors to suit the need and desire of the user or the surroundings.

Referring now to FIG. 4, an embodiment of support structure 20 as used to support an air conditioning unit within a window of a building is shown. As stated previously, although an air conditioning unit is shown in FIG. 4, other objects may be supported by support structure 20, such as flower planters, that may be mounted to a window or directly on the outside surface of a building.

An obvious advantage of support structure 20 of the present invention is that no additional components are necessary to attach the object to support structure 20. Neither is there a need to connect support structure 20 directly to the building for which the object is mounted. Instead, support structure 20 may be independently positioned beneath the location where the object is to be supported. Lower support plate 36 may be placed on a surface 46 substantially perpendicular to inner leg members 32, such as the ground below as shown in FIG. 4. Support structure 20 may be adjusted to the desired vertical height to accommodate the particular window height or desired location, and the object may then be placed on top support plate 30. Gravity forces the weight of the object downward to support structure 20, which is captured between the object and surface 46. This configuration securely supports the object in the desired position adjacent to the building.

While the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

1. An adjustable support structure for supporting an object adjacent to a building, comprising:
a first support assembly;
a second support assembly telescopically connected to said first support assembly;
wherein one of said first support assembly and said second support assembly comprises at least one upwardly extending leg member and is configured to be positioned on a surface substantially perpendicular to said at least one upwardly extending leg member; and
wherein the other of said first support assembly and said second support assembly comprises a top support plate configured to support an object adjacent to the building and is adjustable between a plurality of vertical positions relative to said surface.

2. An adjustable support structure as defined in claim 1, further comprising a component connected to one of said first support assembly and said second support assembly, wherein lateral support and enhanced aesthetics are provided.

3. An adjustable support structure as defined in claim 1, wherein said other of said first support assembly and said second support assembly comprises at least one downwardly extending leg member connected to said top support plate.

4. An adjustable support structure as defined in claim 3, wherein one of said downwardly extending leg member and said upwardly extending leg member comprises a plurality of adjustment holes vertically spaced relative to each other.

5. An adjustable support structure as defined in claim 4, wherein the other of said downwardly extending leg member and said upwardly extending leg member comprises at least one locking hole configured to align with a selected one of said adjustment holes.

6. An adjustable support structure as defined in claim 5, further comprises a locking bolt received in said at least one locking hole and said selected one of said adjustment holes.

7. A support structure, comprising:
an upper support assembly comprising an upper support plate and at least one downwardly extending leg member perpendicular to said upper support plate;
a lower support assembly comprising a lower support plate and at least one upwardly extending leg member perpendicular to said lower support plate and said lower support plate configured to be positioned on a surface substantially perpendicular to said at least one upwardly extending leg member;
wherein said upper support assembly is moveable between a plurality of vertical positions relative to said surface; and
wherein said upper support assembly is configured to support an object connected to a building.

8. A support structure as defined in claim 7, further comprising a decorative component connected to said upper support assembly.

9. A support structure as defined in claim 7, wherein said at least one downwardly extending leg member and said at least one upwardly extending leg member are telescopically connected.

10. A support structure as defined in claim 7, wherein one of said at least one downwardly extending leg member and said at least one upwardly extending leg member comprises a plurality of adjustment holes vertically spaced relative to each other.

11. A support structure as defined in claim 10, wherein the other of said at least one downwardly extending leg member and said at least one upwardly extending leg member comprises at least one locking hole configured to align with a selected one of said adjustment holes.

12. A support structure as defined in claim 10, further comprising a locking bolt received within said at least one locking hole and said selected one of said adjustment holes.

13. An adjustable support structure to support an object, comprising:
an upper support plate;
at least one outer leg member connected to said upper support plate;
a lower support plate;
at least one inner leg member connected to said lower support plate and telescopically received within said at least one outer leg member; and
wherein said lower support plate is configured to be positioned on a surface substantially perpendicular to said at least one inner leg member and said upper support plate is configured to support an object at a selected vertical position relative to said surface.

14. An adjustable support structure as defined in claim 13, wherein said at least one inner support leg is adjustably connected to said at least one outer support leg at a selected vertical location.

15. An adjustable support structure as defined in claim 13, wherein said at least one inner support leg comprises a plurality of adjustment holes vertically spaced relative to each other and said at least one outer leg member comprises at least one locking hole.

16. An adjustable support structure as defined in claim 15, further comprising at least one locking bolt configured to connect said at least one inner leg member to said at least one outer leg member.

17. An adjustable support structure as defined in claim 15, wherein said locking bolt is received within said at least one locking hole and a selected one of said plurality of adjustment holes in said inner leg member.

18. An adjustable support structure as defined in claim 13, wherein said at least one outer leg member may be moved from a first position wherein the support structure is positioned at a first vertical height and a second position wherein the support structure is positioned at a second vertical height.

19. An adjustable support structure as defined in claim 13, further comprising at least one decorative component connected to said at least one outer leg member.
